(19) United States
(12) Patent Application Publication
(10) Pub. No.: US 2025/0260236 A1
(43) Pub. Date: Aug. 14, 2025

(54) SYSTEM AND METHOD FOR SYSTEM-WIDE DER MANAGEMENT IN DISTRIBUTION GRID

(71) Applicant: HITACHI, Ltd., Tokyo (JP)

(72) Inventors: Yanzhu YE, San Jose, CA (US); Natsuhiko FUTAMURA, Santa Clara, CA (US); Panitarn CHONGFUANGPRINYA, San Jose, CA (US); Bo YANG, Santa Clara, CA (US)

(21) Appl. No.: 18/437,956

(22) Filed: Feb. 9, 2024

(51) Int. Cl. H02J 3/38; H04L 67/10

(52) U.S. Cl. CPC H02J 3/381; H04L 67/10; H02J 2203/10; H02J 2300/24

(57) ABSTRACT

Systems and methods involving a cloud distributed integrated node (DIN) composed of one or more servers; and a plurality of edge DINs configured to manage a corresponding region of heterogenous energy sources; which includes intaking data across the heterogenous energy sources of the corresponding region for one or more of the plurality of edge DINs; executing processing on the intaken data to produce a unified output for processing by the cloud DIN; transmitting the unified output to the cloud DIN from the one or more of the plurality of edge DINs; in response to receipt of the unified output from one or more of the plurality of edge DINs, issuing, a command to regulate the heterogenous energy sources of the corresponding region; and controlling the heterogenous energy sources of the corresponding region in response to the command with the one or more of the plurality of edge DINs.

### BACKGROUND

### Field

The present disclosure is generally directed to energy management systems, and more specifically, to system-wide management in distribution grid.

### Related Art

There will be more and more distributed energy resources (DERs) integrated into distribution grids (e.g., roof-top photovoltaics (PVs), energy storage system, electric vehicles (EVs), and so on). Most of these DERs will be deployed behind-the-meter (BTM). The utility operator usually has no direct awareness of these assets, or direct control over these assets. The intermittency and dynamics of these DERs will greatly impact the system operation stability and reliability (e.g. voltage fluctuation, reverse power flow).

FIG. 1 illustrates an example of DERs in a distribution grid involving different DER types, groups and management software. More advanced and versatile software platforms are required to monitor and control these DERs, maintain grid stability and reliability while integrating an increasing number of DERs. The current DER management solutions have several issues.

Scalability: Grid DER assets vary based on types, dynamic characteristics, integration numbers, and so on. The DER management platform should be scalable with increasing number of DERs and growing complexity and diversity in DER portfolios.

Interoperability: There are different DER management software platforms used by different stakeholders. For example, DER management systems (DERMSs) and virtual power plant (VPP) platforms are two types of DER management software platforms. VPP platform takes more of a customer- and aggregator-focused view, with an emphasis on economics and grid functions that can be addressed over a wide geography. DERMSs take a more grid-physics-focused view from the perspective of the utility and grid operator, allowing for localized active power management of distribution feeders. The interoperability among different platforms is also limited due to the proprietary nature of the platforms.

Expandable: The architecture of management platform should be easily expandable to support different new functionalities to meet emerging market and operation needs (e.g., VPP, distribution market services, smart EV scheduling, and so on)

Situational awareness and control of BTM DERs: Current DERMS operated by utility or grid operators lack situational awareness (e.g., BTM DERs), and direct control over the BTM assets.

The adoption of a large number of DERs into grid requires an effective and adaptive framework to address a variety of challenges from the aspects of data integration, asset management and control, etc.

FIG. 2 illustrates an example of a Centralized DERMS system. The current DERMS management architecture usually adopts a centralized system design. The management flow follows top-down principles. Such management architectures have the following constraints:

Limited access/awareness to the large number of BTM assets.

Scalability issues with increasing number and types of DERs in grid.

Complicated network infrastructure and information flow path.

Limited management functions which mostly focuses on grid physics, there are more emerging use cases focusing more on market and economics.

### SUMMARY

As the integrated DER portfolios grow in complexity and diversity, they pose increased challenges for grid operations. DERMS will be vital to ensure that grids can manage changing and dynamic demand as DER adoption becomes dominant in the grid.

As the utility's DER management software, DERMS is usually defined as software-based platforms that provide the ability to continuously monitor and manage diverse and dispersed DERs, both individually and in aggregate, to support multiple objectives related to distribution grid operations. Usually, the DERMS is provided by specific vendors as one single software platform which aggregate and orchestrate all DERs. However, with the increasing number and types of DERs in the grid, utilities increasingly need to work with other DER management software solutions to solve specific, and complex problems (e.g. integrate with VPP platform, third-party aggregation tools, to coordinate with BTM DER clusters).

Currently, utilities increasingly have to work with a combination of different DER management software solutions to solve specific, and sometimes complex issues. A sound integration system and method is needed to not only meet utility objectives but to also address DER-related issues swiftly and economically. Example implementations described herein involve an integration system and method to effectively manage the large number of DERs in grid, which will address various issues that related art DER management solutions faces, such as limited access to wide-area BTM DERs, data and function interoperability between different DER management solutions, limited scalability for the rapid proliferation of DERs, and flexibility to accommodate a variety of operation tasks.

The challenges with DER management not only exist in the controllability of DERs, but also with the two-way information flow, data management, security, communication architectures, system scalabilities, and so on. Meanwhile, the interoperability between different management solutions also brings challenges.

Example implementations described herein involve an integrated system and method for DER monitoring and operation management to provide enhanced features which can involve, but are not limited to, access to the full wide-area DER assets, smooth integration between different management solutions, including data integration, function coordination, and so on, end-to-end solution (edge-to-cloud), as well as layered architecture with scalability and flexibility.

Aspects of the present disclosure can involve a system, which can include a cloud distributed integrated node (DIN) composed of one or more servers; and a plurality of edge DINs, each of the plurality of edge DINs configured to manage a corresponding region of heterogenous energy sources; each of the plurality of edge DINs including a processor, configured to intake data across the heterogenous energy sources of the corresponding region; execute processing on the intaken data to produce a unified output for processing by the cloud DIN; and transmit the unified output to the cloud DIN; wherein the cloud DIN, in response to receipt of the unified output from one or more of the plurality of edge DINs, is configured to issue a command to regulate the heterogenous energy sources of the corresponding region of the one or more of the plurality of edge DINs; wherein the one or more of the plurality of edge DINs controls the heterogenous energy sources of the corresponding region in response to the command.

Aspects of the present disclosure can involve a method for a system involving a cloud distributed integrated node (DIN) composed of one or more servers; and a plurality of edge DINs, each of the plurality of edge DINs configured to manage a corresponding region of heterogenous energy sources; the method including intaking data across the heterogenous energy sources of the corresponding region for one or more of the plurality of edge DINs; executing processing on the intaken data to produce a unified output for processing by the cloud DIN; transmitting the unified output to the cloud DIN from the one or more of the plurality of edge DINs; in response to receipt of the unified output from one or more of the plurality of edge DINs, issuing, from the cloud DIN, a command to regulate the heterogenous energy sources of the corresponding region of the one or more of the plurality of edge DINs; and controlling the heterogenous energy sources of the corresponding region in response to the command with the one or more of the plurality of edge DINs.

### BRIEF DESCRIPTION OF THE DRAWINGS

FIG. 1 illustrates an example of DERs in a distribution grid involving different DER types, groups and management software.

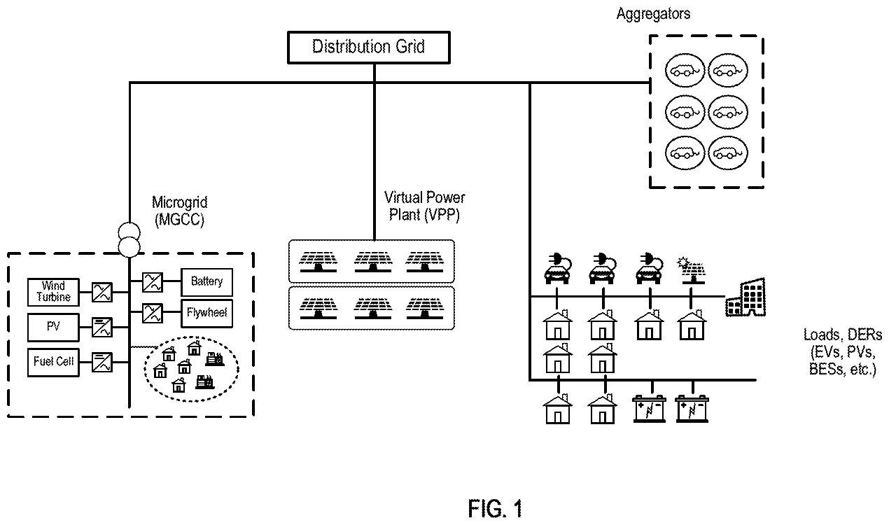

FIG. 2 illustrates an example of a Centralized DERMS system.

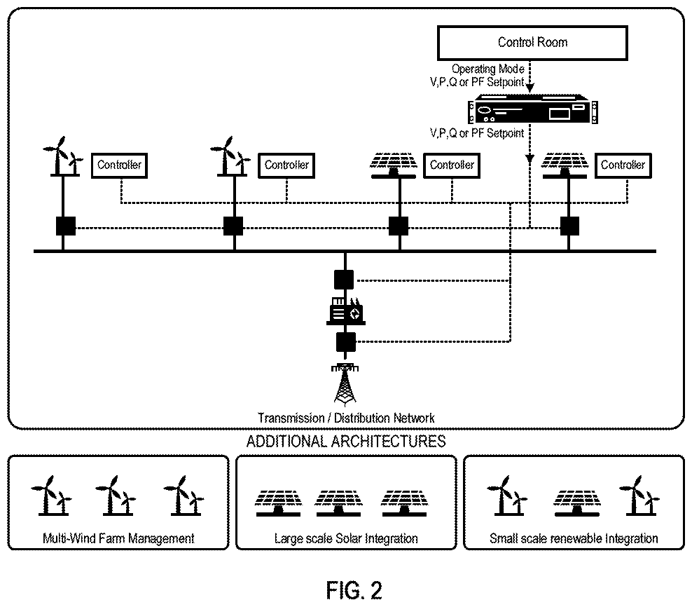

FIG. 3 illustrates a system diagram for DER monitoring and management in a distribution grid, in accordance with an example implementation.

FIG. 4 illustrates an example of the information/data flow between Edge DIN and Field DIN, in accordance with an example implementation.

FIGS. 5A and 5B illustrates an example of the information and network architecture, in accordance with an example implementation.

FIG. 6 illustrates an example of the design architecture of the DINs, in accordance with an example implementation.

FIG. 7 illustrates an example IoT MQTT architecture between DINs, in accordance with an example implementation.

FIG. 8 illustrates an example implementation of the voltage regulation application use case using the proposed DER management system as described in FIG. 3.

FIG. 9 illustrates the example of a command dispatch from cloud DINs to edge DINs, in accordance with an example implementation.

FIG. 10 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented in any manner in accordance with the desired implementation.

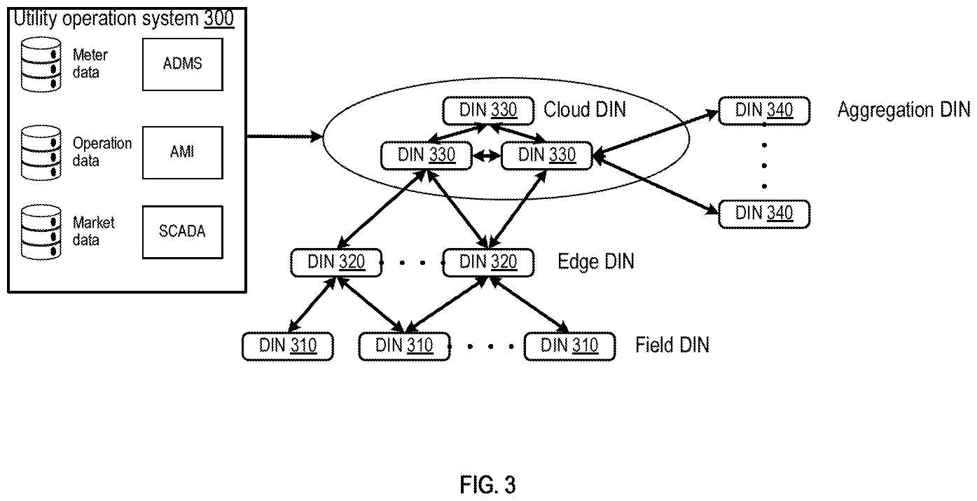

FIG. 3 illustrates a system diagram for DER monitoring and management in a distribution grid, in accordance with an example implementation. Specifically, FIG. 3 illustrates a schematic diagram of the proposed system and method of DER monitoring and operation management in a distribution grid. The distributed intelligent nodes (DINs) can be flexibly deployed in the layered architectures. There are different types of DINs which can fit different network topologies and meets different system operation management needs. The placement of DINs can be adaptively adjusted based on grid system topologies, operation function tasks, and so on.

The implementation of DINs is listed but not limited to the following examples.

Field DINs 310: Field DINs are co-deployed with distributed smart devices physically (e.g. smart meters, smart switches, smart sensors, and so on). When the DIN is co-deployed with existing smart devices in grid, there are three types of implementations that can be utilized. In the hardware sharing implementation, the DINs share the same computing resources and/or communication modules with existing smart devices. A software addition or upgrade is needed to support DIN functions. In the retrofit or hardware upgrade implementation, the existing smart assets need a certain retrofit or hardware upgrade to support DIN functions. A software addition or upgrade is also needed to support DIN functions. In the hardware independent implementation, a separate hardware module is developed and deployed together with existing grid assets. Usually, the communication interface is needed between the independent DINs and field smart assets to effectively communicate data and command.

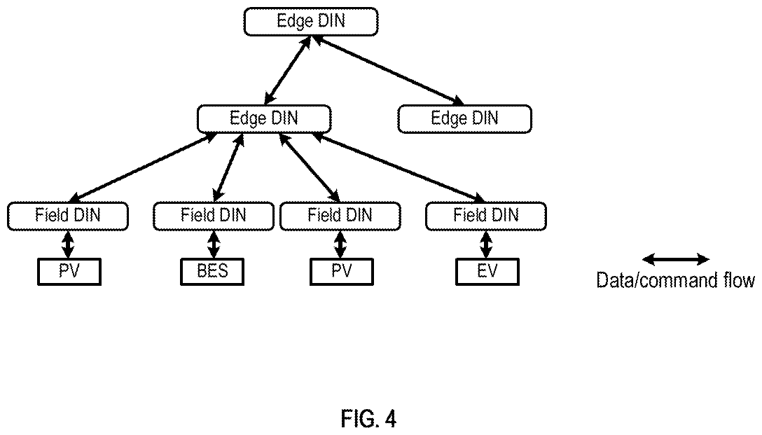

Edge DINs 320: Edge DINs 320 serves as an edge gateway, which directly interacts with one or a cluster of grid assets downstream. They also connect with other edge DINs 320 for upstreaming information or data flow. FIG. 4 illustrates an example of the information/data flow between Edge DIN 320 and Field DIN 310, in accordance with an example implementation. Data exchange can be exchanged from the underlying assets (e.g., photovoltaic, electric vehicle, etc.) and the field DINs 310 and between the field DINs 310 and the edge DINs 320. Field DINs 310 can issue commands and or control the underlying assets based on feedback or commands from the edge DINs 320. Through this manner, edge DINs 320 can control the underlying assets based on the commands issued by the cloud DINs 330. Each of the plurality of field DINs can be connected to a corresponding one of the heterogenous energy sources and configured to provide the data to a corresponding one of the plurality of edge DINs.

Usually, the Edge DIN 320 needs to handle a large amount of data collected from various of DERs in the grid. Besides the basic data concentration and data forwarding functions, some advanced data analytics or data processing functions needs to be developed to improve data efficiency, enhance data security, etc. Some distributed control functions can also be directly deployed on the Edge DINs 320, which will directly control the cluster of smart assets. Edge DINs 320 can be configured to unify the data through execution of such functions to be provided to the cloud DINs 330. Because the functions can unify the data to provide as output for processing by the cloud DINs 330, even if there are heterogenous energy sources or legacy architectures (e.g., devices that require additional field DINs 310 for functionality, inverters, and so on), such heterogenous sources can be managed by the edge DIN 320 in a homogenous manner for processing by the cloud DINs 330.

Cloud DINs 330: Cloud DINs 330 are usually deployed on a central server or cloud, which can act as central controller module responsible for a variety of system operation task (e.g. system voltage regulation, energy trading, energy management, VPP, and so on). Each cloud DIN may involve dedicated computational resources, a software program, and so on, to handle computationally intensive tasks. Such tasks can include, but are not limited to, collecting system-wide or regional operation data, real-time data processing, historical data archival, advanced data analytics, AI/ML-based data analysis, and so on. The utility operation system 300 can provide data such as meter data, operation data, and market data to the Cloud DINs 330.

Aggregation DINs 340: Aggregation DINs 340 are usually located on third-party aggregator platforms, e.g. VPP, EV aggregation management platform, and so on. The functions the aggregation DINs provide can include, but are not limited to, information and data exchange between the third-party aggregation and utility system as well as execution command distribution.

The multi-tiered system architecture as shown in FIG. 3 integrates both top-down and bottom-up information and data flow, including command dispatch and distribution. The design and implementation of DINs in grid system needs to be dynamically adjusted according to grid system topologies, DER deployment scenarios, and system operation requirements, and so on.

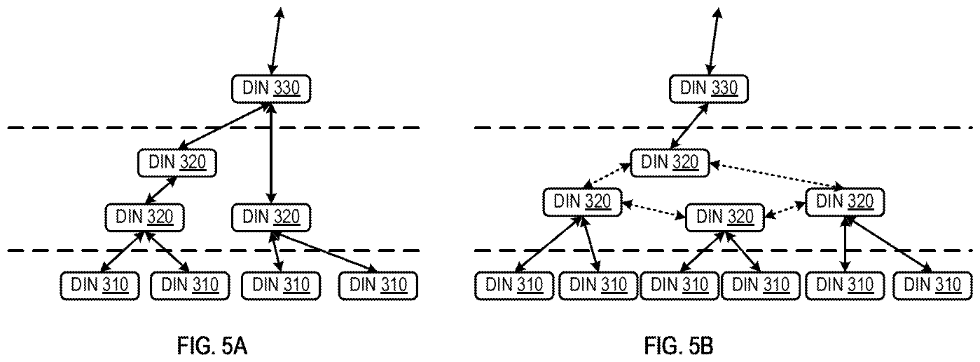

The data communication links are set up among different DINs, DERs and upstream management platforms. Different communication architectures and techniques can be applied at different tiers based on devices types and/or application needs (e.g. wired, wireless, centralized, distributed communication, and so on). The data and information communicated within the system can be configured based on the application needs. FIGS. 5A and 5B illustrates an example of the information and network architecture, in accordance with an example implementation. Specifically, FIG. 5A illustrates an example involving a tree topology, and FIG. 5B illustrates an example involving a hybrid topology.

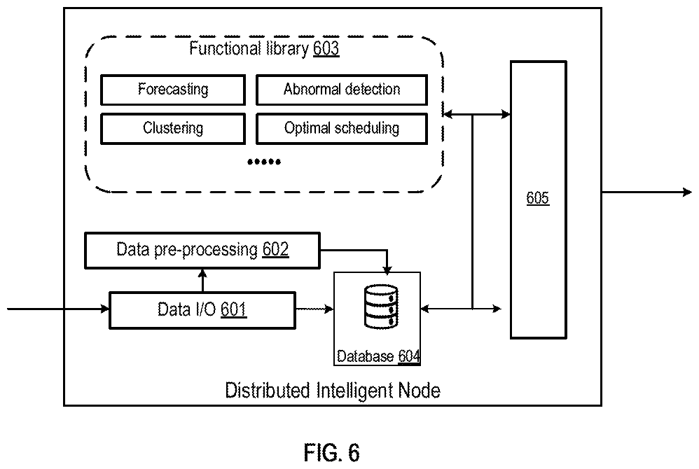

FIG. 6 illustrates an example of the design architecture of the DINs, in accordance with an example implementation. The DIN is a combination of hardware and software. The DINs can be implemented in different ways. For example, for some edge DINs that mainly serve as a data concentration point, such edge DINs can be built on some small single-board computers. For the cloud DINs which receive, process a large amount of data, and perform real-time operational analysis, they can be deployed on a cloud instance.

Data Input/Output (I/O) 601: the DIN has basic data I/O capabilities. DINs receive measurement or status data from one device or clusters of devices. DINs may also interface with other data information system to receive on-demand data. DIN can also be responsible for data concentration, data forwarding to DINs on the same or other tiers.

Data pre-processing 602 can execute a data processing task that can involve, but is not limited to, data synchronization, data resolution adjustment, data integrity checking, data communication protocol conversion, and so on.

The data collected can include, but is not limited to, system operation status (e.g. line power flow, node voltages), smart asset status (e.g. PV reactive/active power injection, battery active power injection, EV charging power, and so on), as well as other data to facilitate the desired implementation. Such data can be directly collected from field smart assets or streamed from other DINs or other management platforms.

Functional library 603 can be optional depending on the desired implementation. The operation functions or analytic functions are optionally implemented on DINs depending on the role of the DINs. For example, for some single-function edge DINs, only data concentration and data forwarding functions are implemented. For some cloud DINs, they provide complex system management functions (e.g., system volt/var control). Depending on the deployment location, the functional library 603 can be categorized to two major types: edge (aggregation) functional library and central (cloud) functional library.

Database 604 is the data collection point that can serve as historical data buffers. The stored data types and data volumes will depend on the computation resources of DINs and the application use cases.

Data publisher/subscriber 605 is a data message bus communication module that publishes and/or receives data. In addition to the normal data I/O which serves as point-2-point data interfaces, the data publisher/subscriber 605 is one of the critical components within DINs. The distributed publish/subscribe mechanism offers more communication flexibility, efficiency, and scalability, especially in the environment with large number of devices, limited bandwidth.

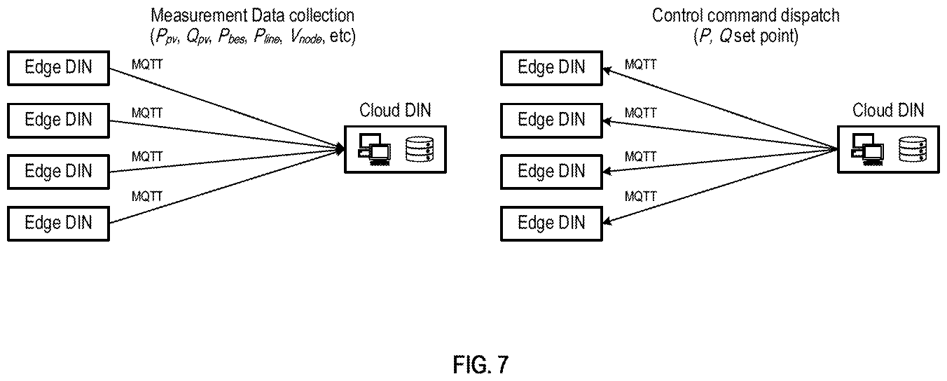

Both the measurement and control commands can be communicated through the message bus. One protocol that can be applied in the architecture is MQ telemetry transport (MQTT). As an efficient IoT communication protocol, MQTT features involve a small data package, low network usage, efficient data distribution, simple data parsing and encoding process, and so on. FIG. 7 illustrates an example IoT MQTT architecture between DINs, in accordance with an example implementation.

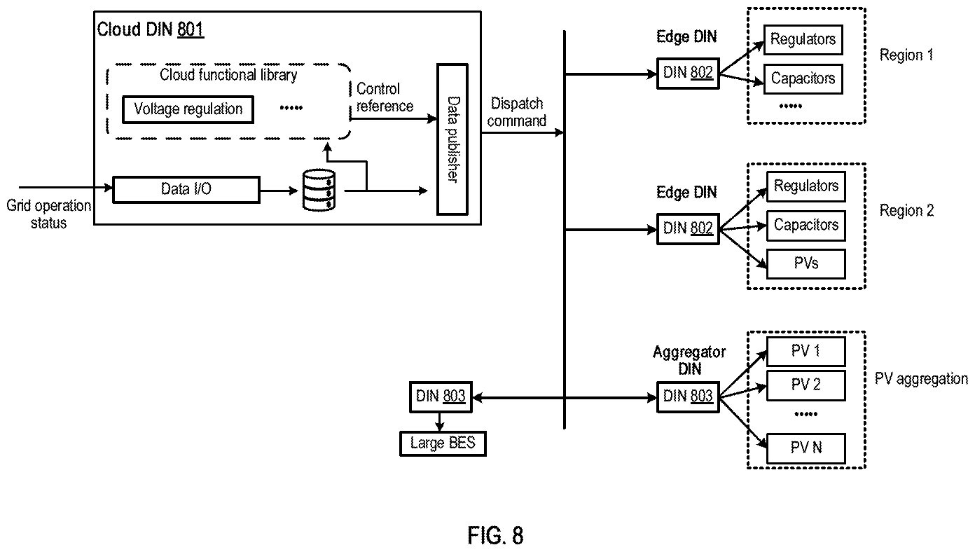

FIG. 8 illustrates an example implementation of the voltage regulation application use case using the proposed DER management system as described in FIG. 3. The grid voltage regulation function is realized through direct or indirect control of a variety of grid assets, including regulators, capacitor, PVs, BESs, etc. There are several key components in FIG. 8.

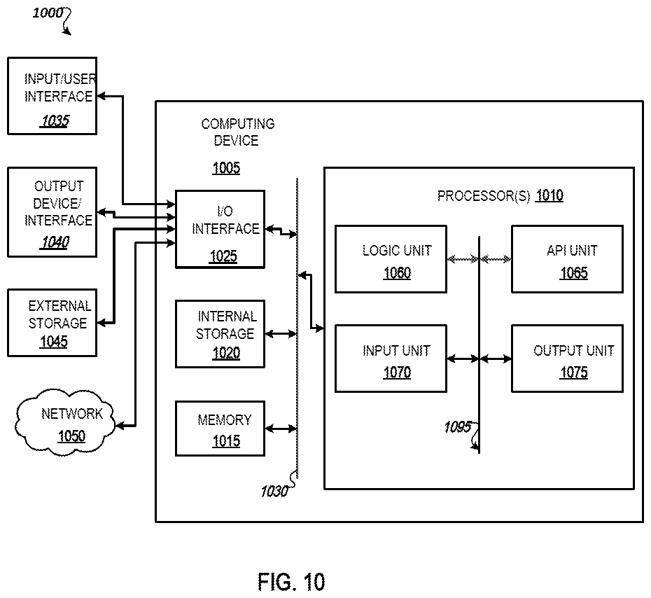

Cloud DIN 801 can be in the form of a functional module located in the utility DERMS, and can take the form of one or more servers such as illustrated in the computing environment of FIG. 10. The cloud DIN 801 receives the grid operation status information from other utility information system (e.g. AMI, DMS, and so on). The grid voltage regulation function can be realized through different approaches (e.g. model-based optimization, data-driven AI-based approach, and so on). The control reference for different grid assets will be generated and passed to different DINs on other tiers (e.g. located on edges, aggregators, and so on).

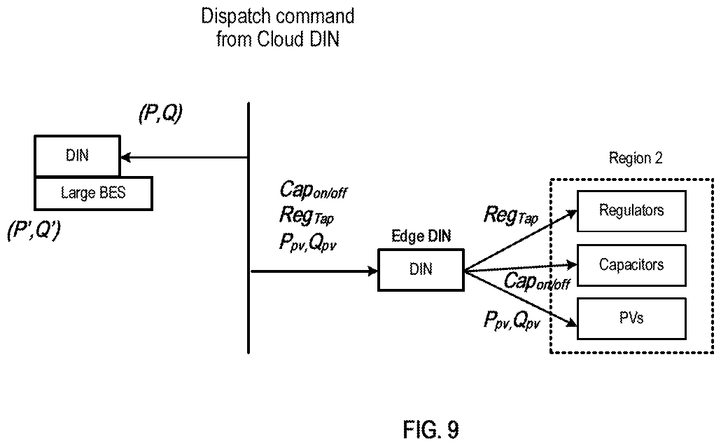

With regard to Edge DINs 802, FIG. 9 illustrates the example of a command dispatch from cloud DINs to edge DINs, in accordance with an example implementation. For DINs interfacing with one individual grid asset (e.g. large-scale BES), the individual control dispatch command will be received. Depending the type of grid asset, the DIN can be part of the on-site asset management system (e.g. battery management system (BMS)). For DINs that serve as edge gateway devices, a group of control references will be received, which include individual dispatch command for each assets, e.g. tap position for regulators (Regtap), reactive power (Qpv) for PV panel, on/off command for capacitors (Capon/off) and so on.

Each of the edge DINs 802 is configured to manage a corresponding region of heterogenous energy sources (e.g., Region 1, Region 2, PV aggregation of FIG. 8), intake data across the heterogenous energy sources of the corresponding region, and execute processing on the intaken data to produce a unified output for processing by the cloud DIN as illustrated in the architecture of FIG. 3. The cloud DIN 801, in response to receipt of the unified output from one or more of the plurality of edge DINs, is configured to issue a command to regulate the heterogenous energy sources of the corresponding region of the one or more of the plurality of edge DINs. As shown in FIG. 8 and FIG. 9, the command can involve a tap position for regulators (Regtap) associated with the one or more of the plurality of edge DINs 802, wherein the one or more of the plurality of edge DINs 802 controls the tap position of the regulator in response to the command. The command can involve an on/off command for capacitors (Capon/off) associated with the one or more of the plurality of edge DINs 802, wherein the one or more of the plurality of edge DINs 802 switches the capacitors on or off in response to the command. The command can include reactive power (Qpv) for a photovoltaic panel associated with the one or more of the plurality of edge DINs, wherein the one or more of the plurality of edge DINs adjust the reactive power of the photovoltaic panel in response to the command. Other commands are also possible to facilitate the desired implementation, and the present disclosure is not limited thereto.

With regards to Aggregator DINs 803, when clusters of DERs are participating the voltage regulation grid services (e.g. EV cluster with V2G capabilities, PV clusters), the aggregator DINs (located on the aggregation management platform) will be responsible for receiving aggregated control reference from central DINs, generating and re-distributing control reference for each individual grid asset. Each of the aggregator DINs 803 can be configured to distribute an aggregated control reference to the heterogeneous energy sources for different control objectives (e.g., such as to manage voltage grid regulation).

Through the example implementations described herein, it is possible to facilitate a multi-tiered system architecture in which the DER management can operate independently on different tiers, as well as interoperate and expand across multiple tiers. Further, the example implementations provided herein facilitate a scalable architecture to support the increasing number of DERs in grid. In addition, the example implementations facilitate a flexible and configurable architecture to accommodate different operation strategies (e.g. centralized, distributed, decentralized, and so on).

FIG. 10 illustrates an example computing environment with an example computer device suitable for use in some example implementations, such as any DIN as described herein. Computer device 1005 in computing environment 1000 can include one or more processing units, cores, or processors 1010, memory 1015 (e.g., RAM, ROM, and/or the like), internal storage 1020 (e.g., magnetic, optical, solid-state storage, and/or organic), and/or IO interface 1025, any of which can be coupled on a communication mechanism or bus 1030 for communicating information or embedded in the computer device 1005. IO interface 1025 is also configured to receive images from cameras or provide images to projectors or displays, depending on the desired implementation.

Computer device 1005 can be communicatively coupled to input/user interface 1035 and output device/interface 1040. Either one or both of the input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005.

Examples of computer device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via IO interface 1025) to external storage 1045 and network 1050 for communicating with any number of networked components, devices, and systems, including one or more computer devices of the same or different configuration. Computer device 1005 or any connected computer device can be functioning as, providing services of, or referred to as a server, client, thin server, general machine, special-purpose machine, or another label.

IO interface 1025 can include but is not limited to, wired and/or wireless interfaces using any communication or IO protocols or standards (e.g., Ethernet, 802.11x, Universal System Bus, WiMAX, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computer device 1005 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided. Processor(s) 1010 can be in the form of hardware processors such as central processing units (CPUs) or in a combination of hardware and software units.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, the input unit 1070, the output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide an output based on the calculations described in example implementations.

Processor(s) 1010 can be configured to execute a method or instructions for an edge DIN, which can include intaking data across the heterogenous energy sources of the corresponding region, execute processing on the intaken data to produce a unified output for processing by the cloud DIN, and transmitting the unified output to the cloud DIN.

Processor(s) 1010 can be configured to execute a method or instructions for a cloud DIN, which can include, in response to receipt of the unified output from one or more of the plurality of edge DINs, issuing a command to regulate the heterogenous energy sources of the corresponding region of the one or more of the plurality of edge DINs, wherein the one or more of the plurality of edge DINs controls the heterogenous energy sources of the corresponding region in response to the command.

Depending on the desired implementation, the command can include a tap position for a regulator associated with the one or more of the plurality of edge DINs, wherein the one or more of the plurality of edge DINs controls the tap position of the regulator in response to the command.

Depending on the desired implementation, the command can involve an on/off command for capacitors associated with the one or more of the plurality of edge DINs, wherein the one or more of the plurality of edge DINs switches the capacitors on or off in response to the command.

Depending on the desired implementation, the command can involve a reactive power for a photovoltaic panel associated with the one or more of the plurality of edge DINs, wherein the one or more of the plurality of edge DINs adjust the reactive power of the photovoltaic panel in response to the command.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored in the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system, comprising:
a cloud distributed integrated node (DIN) composed of one or more servers; and
a plurality of edge DINs, each of the plurality of edge DINs configured to manage a corresponding region of heterogenous energy sources; each of the plurality of edge DINs comprising:
a processor, configured to:
intake data across the heterogenous energy sources of the corresponding region;
execute processing on the intaken data to produce a unified output for processing by the cloud DIN; and
transmit the unified output to the cloud DIN;
wherein the cloud DIN, in response to receipt of the unified output from one or more of the plurality of edge DINs, is configured to issue a command to regulate the heterogenous energy sources of the corresponding region of the one or more of the plurality of edge DINs;
wherein the one or more of the plurality of edge DINs controls the heterogenous energy sources of the corresponding region in response to the command.

2. The system of claim 1, further comprising a plurality of field distributed integrated nodes (DINs), each of the plurality of field DINs connected to a corresponding one of the heterogenous energy sources and configured to provide the data to a corresponding one of the plurality of edge DINs.

3. The system of claim 1, further comprising a plurality of aggregator distributed integrated nodes (DINs), each of the aggregator DINs configured to distribute an aggregated control reference to the heterogeneous energy sources for different control objectives.

4. The system of claim 1, wherein the command comprises a tap position for a regulator associated with the one or more of the plurality of edge DINs, wherein the one or more of the plurality of edge DINs controls the tap position of the regulator in response to the command.

5. The system of claim 1, wherein the command comprises an on/off command for capacitors associated with the one or more of the plurality of edge DINs, wherein the one or more of the plurality of edge DINs switches the capacitors on or off in response to the command.

6. The system of claim 1, wherein the command comprises a reactive power for a photovoltaic panel associated with the one or more of the plurality of edge DINs, wherein the one or more of the plurality of edge DINs adjust the reactive power of the photovoltaic panel in response to the command.

7. A method for a system involving a cloud distributed integrated node (DIN) composed of one or more servers; and a plurality of edge DINs, each of the plurality of edge DINs configured to manage a corresponding region of heterogenous energy sources; the method comprising:
intaking data across the heterogenous energy sources of the corresponding region for one or more of the plurality of edge DINs;
executing processing on the intaken data to produce a unified output for processing by the cloud DIN;
transmitting the unified output to the cloud DIN from the one or more of the plurality of edge DINs;
in response to receipt of the unified output from one or more of the plurality of edge DINs, issuing, from the cloud DIN, a command to regulate the heterogenous energy sources of the corresponding region of the one or more of the plurality of edge DINs; and
controlling the heterogenous energy sources of the corresponding region in response to the command with the one or more of the plurality of edge DINs.

8. The method of claim 7, wherein the system further comprises a plurality of field distributed integrated nodes (DINs), each of the plurality of field DINs connected to a corresponding one of the heterogenous energy sources, the method further comprising providing the data to a corresponding one of the plurality of edge DINs from the plurality of field DINs.

9. The method of claim 7, wherein the system further comprises a plurality of aggregator distributed integrated nodes (DINs), the method further comprising, distributing an aggregated control reference to the heterogeneous energy sources for different control objectives from the plurality of aggregator DINs.

10. The method of claim 7, wherein the command comprises a tap position for a regulator associated with the one or more of the plurality of edge DINs, wherein the method comprises controlling the tap position of the regulator associated with the one or more of the plurality of edge DINs in response to the command.

11. The method of claim 7, wherein the command comprises an on/off command for capacitors associated with the one or more of the plurality of edge DINs, wherein the method further comprises switching the capacitors associated with the one or more of the plurality of edge DINs on or off in response to the command.

12. The method of claim 7, wherein the command comprises a reactive power for a photovoltaic panel associated with the one or more of the plurality of edge DINs, wherein the method further comprises adjusting the reactive power of the photovoltaic panel associated with the one or more of the plurality of edge DINs in response to the command.
